(19) United States
(12) Patent Application Publication
(10) Pub. No.: US 2016/0029225 A1
(43) Pub. Date: Jan. 28, 2016

(54) Active Antenna System And Method With Full Antenna Ports Dimension

(71) Applicant: Alcatel-Lucent USA Inc., Murray Hill, NJ (US)

(72) Inventor: Teck Hu, Melbourne, FL (US)

(73) Assignee: Alcatel-Lucent USA Inc., Murray Hill, NJ (US)

(21) Appl. No.: 14/337,328

(22) Filed: Jul. 22, 2014

(51) Int. Cl. H04W 16/28; H04B 1/40

(52) U.S. Cl. CPC H04W 16/28; H04B 1/40; H04W 88/08

(57) ABSTRACT

An Active Antenna System (AAS) is used to generate a logical port by performing beam forming operations to process a reference signal applied to its input. The beam forming operations are based on AAS configuration information received by the AAS. The beam forming operations map different operations to different components of the AAS where said operations are performed during the processing of the reference signal resulting in a beam that may be directed at a particular location with a certain amount of power. The AAS configuration information is received by a processor coupled to all of the components of the AAS and said processor converts the received AAS configuration information to control signals causing said components to perform the beam forming operations.

### FIELD OF THE INVENTION

The present invention generally relates to antenna systems and in particular to a method for providing antenna functions for an antenna system.

### BACKGROUND OF THE INVENTION

Traditionally, specifications for base stations of wireless communication systems would typically include, inter alia, detailed descriptions of the signals, the power of the signals and their spectral and temporal components transmitted or received (or both) by a base station. Even though base stations would usually have antennas as part of their equipment, the particular specification describing the operation of the antennas would not usually be part of the specification of a base station. In particular, signals conveyed (transmitted or received or both) by a base station were defined up to the point of a physical interface between base station circuitry and the antenna for that base station. A cable (e.g., a coaxial cable) would usually form the interface that provided a physical connection between base station circuitry and an antenna. The antenna would be driven by signals from the base station circuitry and thus radiate a certain antenna beam (or radiation pattern) of a certain power at a particular direction. For isotropic antennas, the EIRP (Equivalent Isotropically Radiated Power) of the antenna would be defined. Depending on the antenna radiation pattern and output power desired, different antennas with different operational characteristics would be used.

### BRIEF SUMMARY OF THE INVENTION

The device of the present invention is an Active Antenna System (AAS) that is integral with a base station or other equipment of a communication network (e.g., a cellular communication network) within which the AAS operates. The base station is serving a particular cell (defined geographic area) of the wireless communication network. One embodiment of the AAS device of the present invention comprises a plurality of transceivers (i.e., a Transceiver Bank) coupled to at least one Antenna Array (each array comprising a plurality of antenna elements) via a Radio Distribution Network (RDN), which Radio Distribution Network comprises controllable switches for routing signals applied to the Transceiver Bank to the Antenna Array to form a desired beam spatially directed at a particular desired geographical location or area, at a particular terminal (mobile or fixed), or at one or more groups of terminals at the same or different locations.

The AAS of the device of the present invention uses particular information that defines various dynamic beam forming operations performed by the Transceiver Bank, the Radio Distribution Network (RDN) and the Antenna Array on one or more reference signals applied to at least one input of the AAS (e.g., a Transceiver input) to generate a beam from the processing of the one or more reference signals where such beam may be directed at a particular terminal (mobile or fixed), one or more groups of terminals, or a geographical area. The directed beam of the reference signal being a logical port of the AAS in general and more particularly a logical port of the Antenna Array. The particular information thus defines a dynamic mapping of one or more logical ports (i.e., one or more processed reference signals into a beam) to the AAS.

The term ‘dynamic beam forming operations’ refers to certain tasks performed by one or more of the components of the AAS to form beams based the particular information applied to the AAS for a defined period of time (or a desired period of time). The dynamic beam forming operations can be performed for a defined period of time, or for as long as needed or desired, using any one or more of the antenna elements. A beam formed from a dynamic beam forming operation has a particular shape, physical range, power allocation, and power distribution for coverage of (i) a specific geographical area; (ii) a specific terminal (mobile or fixed) at a particular location; (iii) one or more groups of terminals (fixed or mobile) within one defined area or different defined areas. The particular information on which the dynamic beam forming operations are based (or which defines the dynamic beam forming operations) is referred to as AAS configuration information.

The AAS configuration information is information that identifies the particular selected transceivers, the amount of power allocated to the particular selected transceivers, the particular routing of signal(s) applied to particular selected transceivers through selected switches of the RDN to the particular antenna elements needed to perform beam forming operations for a desired beam directed at a specific terminal (mobile or fixed), a particular geographical location or area, or one or more groups of terminals at the same location or at different locations.

When the applied signal is a reference signal (which may comprise one or more signals), which is a signal defined by the communication network (i.e., is part of the specifications of the communication network), or defined by one or more communication standard (and their associated protocols) being followed by the communication network within which the AAS operates, the resulting beam formed from the dynamic beam forming operations to process this reference signal inputted to the AAS of the present invention (one embodiment of which is depicted in FIG. 1), is a logical port of the Antenna Array.

A logical port (or a generated beam of a reference signal) may or may not be generated for a defined time period. In many cases, the beam that is formed may be generated for as long as circumstances dictate. Each of the transceivers may include, as part of their circuitry, power amplifiers that can drive one or more of the antenna array elements via the Radio Distribution Network. The power amplifiers may include filters that serve to limit and/or define the frequency content of the signals applied to the transceivers. Further, each of the transceivers is also capable of imparting a certain phase to each of the applied signals. Thus, based on these capabilities of the transceivers and radiation profiles of the antenna array elements, the shape and direction of a beam can be designed as desired before it is generated. Yet further, the transceiver or transceivers to which a signal is applied may adjust the power level and the frequency content of the signal. The beam is thus designed and realized through the use of the circuitry discussed above, which may be part of a base station of a cellular communication network, or integral with the base station. The AAS operates within the cellular communication network or wireless communication network.

The method of the present invention performs the steps for various beam forming operations dictated by AAS configuration information (received by the AAS) to process one or more reference signals inputted into the AAS whereby some of these operations may be performed for a defined time period or for as long as desired. All of the steps of the method the present invention may be performed by an AAS that is integral with a base station of a cellular communication network within which the AAS operates. The AAS configuration information may originate from the communication network or may be generated by the network based on the network complying with the communication standard (e.g., certain protocols) being followed by the communication network. For example, the base station (or other network equipment) may generate AAS configuration information based on rules (communication standard and associated protocols) of the cellular network and/or based on information (from operators or users of the network, for example) describing the current tasks needed to be performed to meet the demands of the network.

The method of the present invention determines whether there are sufficient resources available to perform the desired beam forming operations to generate one or more beams. In particular, in order to form the desired beam, the AAS first determines, based on the AAS configuration information, the following: (i) the particular transceivers to be used; (ii) the particular switches in the RDN to be used, (iii) the particular antenna elements to be used; (iv) the amount of power used by the selected transceivers to drive the selected antenna elements; and (v) the proper amount of power to be allocated to the AAS to perform the beam forming operations for the desired beam. If there are sufficient resources, then the AAS is operated so that the one or more beams are formed; otherwise the method of the present invention waits until sufficient resources are available to form the desired one or more beams.

### BRIEF DESCRIPTION OF THE DRAWINGS

FIG. 1 shows an embodiment of the present invention in which a processor is used to generated the proper control signals for operation of the AAS shown.

FIG. 2 shows a particular architecture utilizing multiple AASs.

FIG. 3 shows the AAS architecture of FIG. 2 applied to a cellular communication network.

FIG. 4 is a flow chart of one embodiment of the method of the present invention.

### DETAILED DESCRIPTION

The device of the present invention is an Active Antenna System (AAS) that is integral with a base station or other equipment of a communication network (e.g., a cellular communication network) within which the AAS operates. The base station is serving a particular cell (defined geographic area) of the wireless communication network. One embodiment of the AAS device of the present invention comprises a plurality of transceivers (i.e., a Transceiver Bank) coupled to at least one Antenna Array (each array comprising a plurality of antenna elements) via a Radio Distribution Network (RDN), which Network comprises controllable switches for routing signals applied to the Transceiver Bank to the Antenna Array to form a desired beam spatially directed at a particular desired geographical location or area, at a particular terminal (mobile or fixed), or at one or more groups of terminals at the same or different locations.

The AAS of the device of the present invention uses AAS configuration information that defines various dynamic beam forming operations performed by the Transceiver Bank, the Radio Distribution Network (RDN) and the Antenna Array on one or more reference signals applied to an input of the AAS (e.g., a Transceiver input) to generate a beam from the processing of the one or more reference signals where such beam may be directed at a particular terminal (mobile or fixed), one or more groups of terminals, or a geographical area. The directed beam of the reference signal being a logical port of the AAS in general and more particularly a logical port of the Antenna Array. The AAS configuration information thus defines a dynamic mapping of one or more logical ports (i.e., one or more processed reference signals into a beam) to the AAS.

The term ‘dynamic beam forming operations’ refers to certain tasks performed on one or more of the components of the AAS to form beams based on AAS configuration information applied to the AAS for a defined period of time (or a desired period of time). The dynamic beam forming operations can be performed for a defined period of time, or for as long as needed or desired, using any one or more of the antenna elements. A beam formed from a dynamic beam forming operation has a particular shape, physical range, power allocation, and power distribution for coverage of (i) a specific geographical area; (ii) a specific terminal (mobile or fixed) at a particular location; (iii) one or more groups of terminals (fixed or mobile) within one defined area or different defined areas. The particular information on which the dynamic beam forming operations are based is referred to as AAS configuration information.

The AAS configuration information is information that identifies the particular selected transceivers, the amount of power allocated to the particular selected transceivers, the particular routing of signal(s) applied to particular selected transceivers through selected switches of the RDN to the particular antenna elements needed to perform beam forming operations for a desired beam directed at a specific terminal (mobile or fixed), a particular geographical location or area, or one or more groups of terminals at the same location or at different locations.

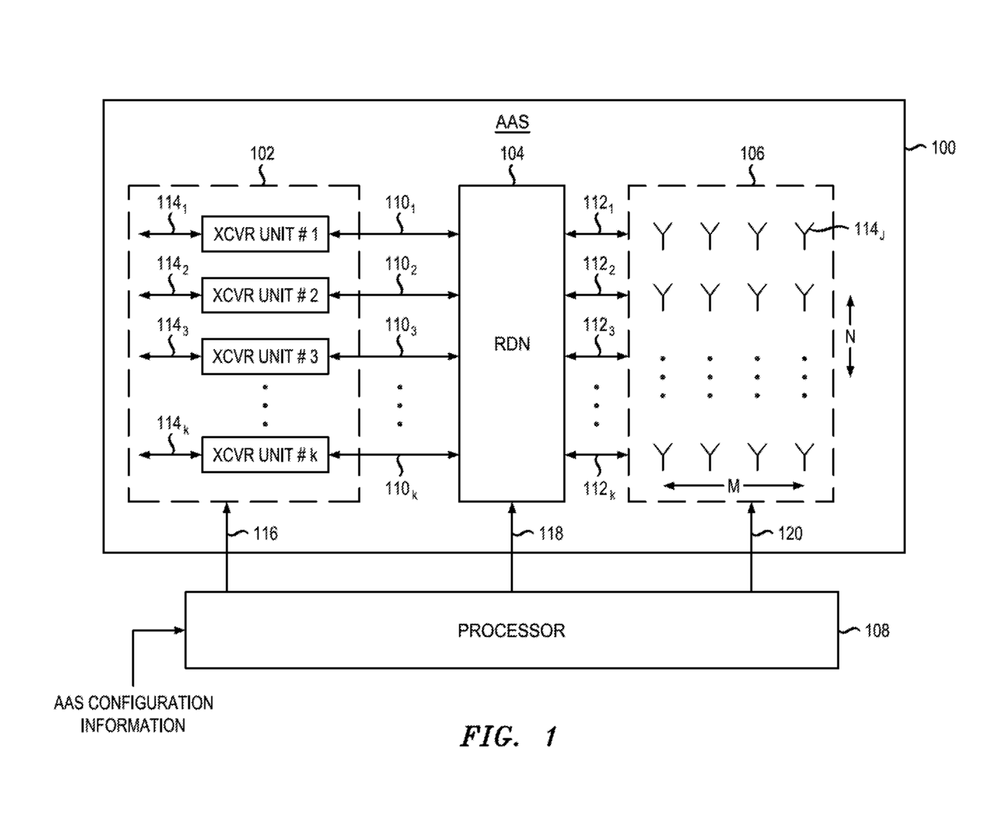

When the applied signal is a reference signal (which may comprise one or more signals), which is a signal defined by the communication network (i.e., is part of the specifications of the communication network), or defined by one or more communication standard (and their associated protocols) being followed by the communication network within which the AAS operates, the resulting beam formed from the dynamic beam forming operations to process this reference signal inputted to the AAS of the present invention (one embodiment of which is depicted in FIG. 1), is a logical port of the Antenna Array.

A logical port (or a generated beam of a reference signal) may or may not be generated for a defined time period. In many cases, the beam that is formed may be generated for as long as circumstances dictate. Each of the transceivers may include, as part of their circuitry, power amplifiers that can drive one or more of the antenna array elements via the Radio Distribution Network. The power amplifiers may include filters that serve to limit and/or define the frequency content of the signals applied to the transceivers. Further, each of the transceivers is also capable of imparting a certain phase to each of the applied signals. Thus, based on these capabilities of the transceivers and the radiation profile of the antenna array elements, the shape and direction of a beam can be designed as desired before it is generated. Yet further, the transceiver or transceivers to which a signal is applied may adjust the power level and the frequency content of the signal. The beam is thus designed and realized through the use of the circuitry discussed above, which may be part of a base station of a cellular communication network, or integral with the base station. The AAS operates within the cellular communication network or wireless communication network.

The terminals (mobile or fixed) at which the logical ports are directed can use the information received from the logical ports to perform certain communication network or communication standard defined tasks such as modulation, coherent detection, synchronization with different channels between mobile terminals. The beams formed using the AAS device and method of the present invention are not limited (or dedicated) to certain antenna elements, transceivers or RDN switches of the AAS. It will be understood that different transceivers, RDN switches and antenna elements can be used to form the same or different beams or logical ports at different times for different time durations. In other words, no particular combination of antenna elements, transceivers and routing switches on which dynamic beam forming operations are performed are dedicated to any of the formed beams or logical ports.

Similar to a specification for a base station that describes the operation of the base station, the specification for an antenna can describe the various ports of the antenna and the characteristics of each of said ports. Thus, a specification for an antenna, such as the Antenna Array of an embodiment of the AAS of the present invention, can comprise AAS configuration information that defines the dynamic mapping (i.e., dynamic beam forming operations) of an input reference signal, processed by the Transceiver Bank, RDN, and Antenna Array of the AAS resulting in a beam (i.e., a logical port) directed at a terminal or terminals, a group or groups of terminals, or a specific geographical area.

The AAS device and method of the present invention are capable of forming different types of beams or beam configurations. For example, the following beam forming configurations can be performed: (1) Cell specific vertical or horizontal beam forming; (2) UE specific vertical or horizontal beam forming; (3) higher order MU-MIMO (Multi User Multiple Input Multiple Output) across all antenna ports both in azimuth and elevation dimensions; and (4) FD-MIMO (Full Dimension MIMO). In cell specific beamforming, the cell is separated by the beam formed either in the vertical or horizontal dimension. Alternatively, the beam specific to each UE can be formed. The AAS device can also be used to provide spatial multiplexing through such techniques as MU-MIMO and FD-MIMO, where for the latter technique a higher dimension of logical ports is utilized.

In one embodiment, the components of the AAS form an integral device whereby the AAS is a single integral circuit having a common substrate (or a common circuit board) on which all of the circuitry for the Transceiver Bank, the Radio Distribution Network and Antenna Array are mounted. In another embodiment, the AAS device may include a processor or controller that provides all of the control signals to the Transceiver Bank, the Radio Distribution Network and the Antenna Array for performing beam forming, including the usage of logical ports, based on the AAS configuration information.

The signal or signals from which a beam is generated are applied to at least one transceiver of the Transceiver Bank, which amplifies or otherwise processes the signal or signals based on at least a certain amount of power provided to such at least one transceiver. The output of the at least one transceiver is routed through the RDN (Radio Distribution Network) by activating one or more of the controllable switches of the RDN to drive one or more of the antenna elements of the at least one Antenna Array. Each antenna element of the Antenna Array has a defined beam pattern or radiation pattern (of certain frequencies or set of frequencies) that results when a defined signal comprising certain frequency components within a frequency band having a certain range of amplitude or power value is used to drive the antenna element; this resulting beam pattern is referred to as the ‘radiation profile’ of the antenna element. This radiation profile may, for example, represent RF (Radio Frequency) characteristics of the Antenna Array where such characteristics are defined by the AAS configuration information that dictated how and which beam forming operations are performed. Thus, with a priori knowledge of the radiation profile of each of the antenna elements, the AAS device of the present invention allows for the construction or design (or both) of a desired beam without having to actually apply a signal to the antenna elements. The Antenna Array can be designed to have different groups of antenna elements with each group having a different radiation profile. Alternatively all antenna elements of an Antenna Array can have the same radiation profile.

The method of the present invention performs the steps for various beam forming operations dictated by AAS configuration information (received by the AAS) to process one or more reference signals inputted into the AAS whereby some of these operations may be performed for a defined time period. All of the steps of the method the present invention may be performed by an AAS that is integral with a base station of a cellular communication network within which the AAS operates. The AAS configuration information may originate from the communication network or may be generated by the network in complying with the communication standard (e.g., certain protocols) being followed by the communication network. For example, the base station (or other network equipment) may generate AAS configuration information based on rules (communication standard and associated protocols) of the cellular network and/or based on information (from operators or users of the network, for example) describing the current tasks needed to be performed to meet the demands of the network.

A base station integral with the AAS or capable of communicating with the AAS may generate various control signals based on AAS configuration information that it receives. The AAS configuration may be generated by one or more equipment of communication a network within which the AAS operates. The AAS configuration information or corresponding control signals associated with the AAS configuration information are applied to the Transceiver bank, the Radio Distribution Network and the Antenna array of the AAS to cause the AAS to perform dynamic beam forming operations in accordance with the AAS configuration information on one or more reference signals applied to inputs of the AAS. In another embodiment, the AAS may have the proper processing capabilities to generate control signals from received AAS configuration information. In short, the AAS configuration information is converted to various control signals applied at the appropriate time to the various components of the AAS device. The control signals may be generated with the use of a (e.g., microprocessor, digital signal processor, microcontroller, controller, server, computer system or any combination thereof); the processor may be part of the AAS device or may be separate from the AAS device. The AAS may be allocated sufficient power to perform the required beam forming operations within any time constraint dictated by the AAS configuration information. A determination of the type and amount of resources (e.g., antenna elements, transceivers, time representing duration of the beam, and power requirements for the generation of the beam) needed to perform the beam forming operations may be done by the AAS based on the AAS configuration information. The resources needed to perform the beam forming operations are part of resource deployment tasks performed by the communication network within which the AAS operates. Thus, the AAS configuration information may be based on resource deployment tasks performed by the communication network in which the AAS operates.

The method of the present invention determines if there are sufficient resources available to perform the desired beam forming operations to generate one or more beams. In particular, in order to form the desired beam, the AAS first determines, based on the AAS configuration information, the following: (i) the particular transceivers to be used; (ii) the particular switches in the RDN to be used, (iii) the particular antenna elements to be used; (iv) the amount of power used by the selected transceivers to drive the selected antenna elements; and (v) the proper amount of power to be allocated to the AAS to perform any one or more of various tasks using the logical port. If there are sufficient resources, then the AAS is operated so that the one or more beams are formed and used as a logical port as dictated by the communication network (or communication standard(s) of the communication network) within which the AAS operates; otherwise the method of the present invention waits until sufficient resources are available to form the desired one or more beams. The beam forming operations are performed for a defined period of time based on any time constraints included in the AAS configuration information. Upon the lapsing of the time duration associated with the time constraint, the beam forming operation is terminated. Otherwise, the duration of the beam forming operations is performed to meet the requirements dictated by the AAS configuration information or dictated by the particular logical port being generated.

Referring to FIG. 1, an Active Antenna System (AAS) of the present invention is depicted. For ease of explanation the AAS system will be described in the context of a communication network (e.g., a cellular or wireless communication network) operated in accordance with a communication standard (and associated protocols) with which the network and thus the AAS complies. One example of a communication standard is the 4G LTE standard. It should be noted, however, that the use of the AAS of the present invention is not limited to any particular type of communication network or communication standard. The AAS of the present invention comprises a Transceiver Bank 102 having a plurality of transceivers (transceiver unit 1, 2, 3, . . . , K) each of which has an input 114₁, 114₂, 114₃, . . . , 114_{K}; (K is an integer equal to 2 or greater) and each of which is coupled to one of a first set of I/Os (Input/Outputs) of Radio Distribution Network (RDN) 104. The first set of I/Os shown are 110₁, 110₂, 110₃, . . . , 110_{K}. The RDN 104 also has a second set of K I/Os (112₁, 112₂, 112₃, . . . , 112_{K}). Each of the second set of I/Os may be coupled to an I/O of Antenna Array 106. The Antenna Array comprises N rows of antenna elements each row having M columns (N and M are integers equal to 1 or greater) resulting in J antenna elements where J=1, 2, 3, . . . , N·M (J is an integer equal to 1 or greater). Each of the antenna elements (116₁, 116₂, 116₃, . . . , 116_{N·M}) inherently has an I/O portion as it can transmit and/or receive electromagnetic signals over the air. For example, electromagnetic signals received by one or more of the antenna array elements are routed to one or more of the second set (112₁, 112₂, 112₃, . . . , 112_{K}) of K I/Os of RDN 104 through the RDN 104 and then to one or more of the transceivers via first set of I/Os (110₁, 110₂, 110₃, . . . , 110_{K}) to appear at one or more of the set of I/Os (114₁, 114₂, 114₃, . . . , 114_{K}) after having been processed by one or more of the transceivers of Transceiver Bank 102. Conversely, one or more signals applied to one or more of the I/Os 114₁, 114₂, 114₃, . . . , 114_{K} of the Transceiver Bank 102 is processed and appear at one or more transceiver I/Os 110₁, 110₂, 110₃, . . . , 110_{K} through RDN 104 and to one or more antenna elements via I/Os 112₁, 112₂, 112₃, . . . , 112_{K} to generate a beam as part of a beam forming operation.

The particular power amplification by the transceivers, the particular routing through the RDN and the particular selection of antenna elements in performing such a beam forming operation are controlled by the control signals on signals paths 116, 118 and 120 respectively. The control signals applied to AAS 100 are shown as originating from processor 108 which generates such signals based on AAS configuration information applied to or received by the processor 108. It is understood that the AAS configuration information may be processed by one or more devices and/or circuits, microprocessor, digital signal processor or any combination thereof to generate the control signals for the various blocks of the AAS 100; the present invention is not limited to the use of a processor, such as processor 108, to generate the control signals from the AAS configuration information. Other implementations can be realized wherein the AAS configuration information is converted to control signals by the AAS having internal circuitry or internal processor circuitry to allow the AAS of the present invention to perform beam forming including beams formed to operate as logical ports. Thus, by applying the proper power to selected transceivers to which an input signal is applied, by combining the proper antenna elements through the proper routing of the signals through the RDN, a beam forming operation can be performed wherein the shape, range, and power of the formed beam can be selectively controlled. The logical ports are formed from a reference signal and can be directed at a particular mobile or fixed terminal that is in communication with a cellular network using the AAS of the present invention as part of the base station radio circuitry.

The AAS configuration information may be generated by network circuitry or network servers or computers that operate in accordance with the communication standard (and associated protocol) being followed by the wireless or cellular communication network within which a base station comprising at least the AAS device of the present invention—one embodiment of which is shown in FIG. 1. The AAS configuration information may be based on or may be generated from various functions performed by one or more node elements of the communication network in establishing communications between two mobile terminals (for example) or for maintaining a communication session once it has been established where the communication session and the establishment of same are performed in accordance with the communication standards being the followed by the communication network. A node element is equipment or a group of equipment that perform certain defined functions within a communication network. Examples of a node element include base stations, communication servers, mobile or fixed terminals. The node elements are part of a communication network within which the AAS operates.

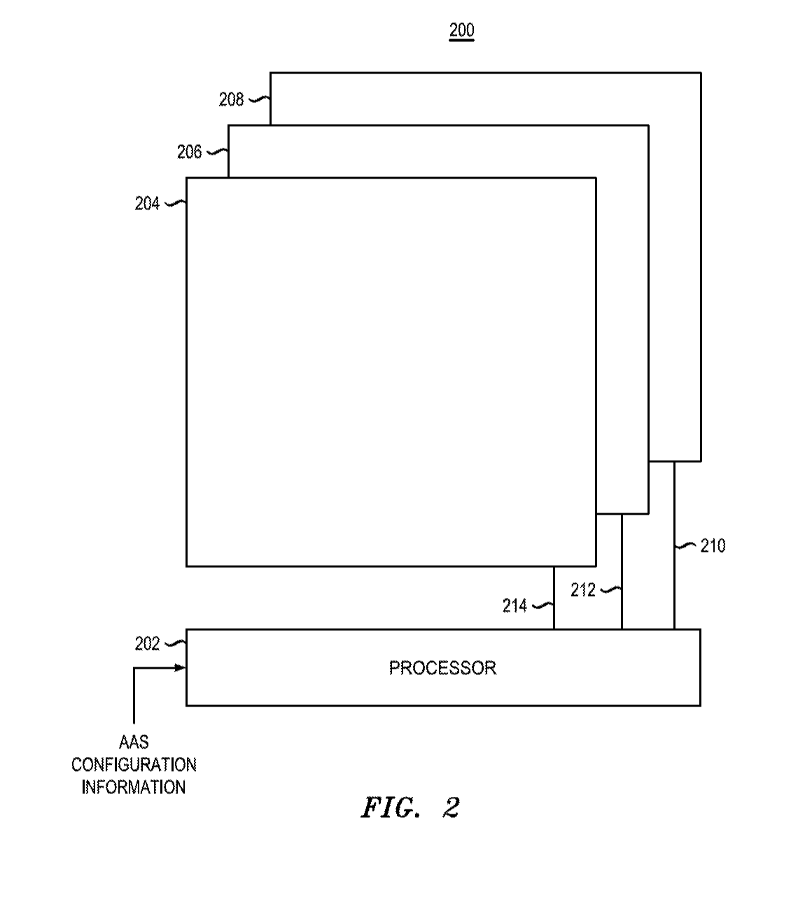

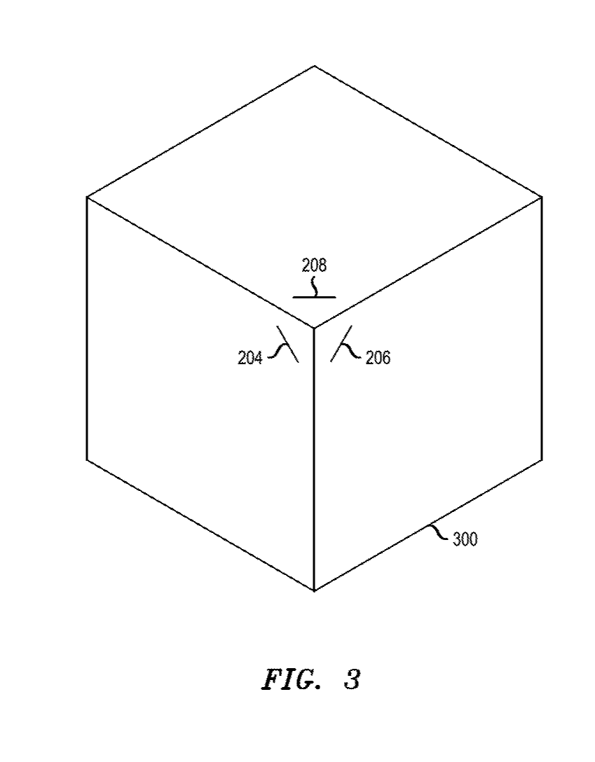

Referring to FIG. 2, a particular architecture 200 for three AASs is shown. AAS 204, 206 and 208 are substantially similar in operation and configuration to AAS 100 discussed above. Processor 202 receives AAS configuration information for all three AASs. AAS configuration information may be labeled in any well known manner to indicate for which AAS a particular block of AAS configuration information is destined. Processor 202 receives AAS configuration information for the three AASs (204, 206 and 208), determines the destination of the received AAS configuration information and generates the proper control signals for the proper AAS. Control signals for AAS 204 are generated on path 214, for AAS 206 on path 212 and for AAS 208 on path 210. One particular application of the AAS architecture 200 may be the coverage on different parts of a cell that is part of a cellular communication network as shown in FIG. 3.

Referring to FIG. 3, cell 300 is divided into three geographical areas as shown. The system shown in FIG. 2 is used to provide antenna coverage for the entire cell by assigning a separate AAS to each portion of the cell as shown. The different AASs receive control signals from a single processor where such control signals are generated from AAS configuration information received for a particular AAS.

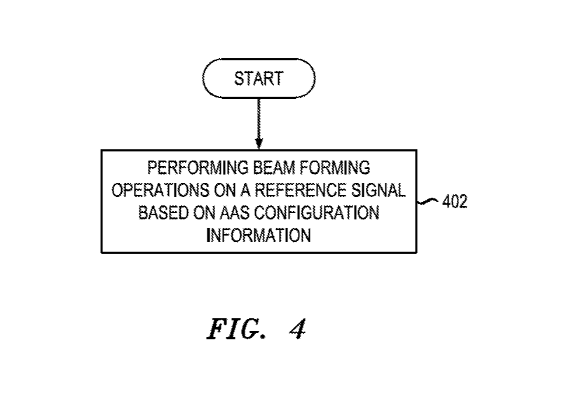

Referring to FIG. 4, one embodiment of the method of the present invention is shown. An AAS is first provided and a reference signal is applied to one of its inputs. For the embodiment shown in FIG. 1, the reference signal is applied to an input of one of the Transceivers of the Transceiver Bank 102. Thus, in step 402, the method of the present invention provides an AAS that performs beam forming operations to process a reference signal applied to an input of the AAS where the beam forming operations are based on AAS configuration information received by the AAS. The AAS receives AAS configuration information dictating the particular beam forming operations to be performed on the various components of the AAS to process the input signal resulting in beam that represents a logical port of the Antenna Array of the AAS. The AAS configuration information may be received by a processor that converts such information to control signals to cause the beam forming operations to be performed on the appropriate components of the AAS at the appropriate time.

The beam forming operations are performed for a period of time defined by the AAS configuration information. The length of time may be defined by the AAS configuration information. The length of time for which the beam forming operations are performed may also be based on particular tasks being performed by a communication network within which the AAS operates. For example, the particular information being conveyed over the logical port generated by the AAS may be information needed to perform the steps of a particular protocol of a standard being followed by a communication network within which the AAS operates. Prior to performing beam forming operations to process the input signal, the AAS determines whether there are sufficient resources available to perform the beam forming operations required or dictated by the received AAS configuration information. The resources may be the various components of the AAS as described supra (with respect to FIG. 1) and also the amount of power allocated to the AAS or the amount of power allocated to the logical ports of the AAS.

The AAS configuration information may be received directly by the AAS or may be received by a processor in communication with the AAS which processor converts the AAS configuration information to control signals. The control signals are applied to the AAS by the processor which may form part of the AAS or may be in communication with the AAS. Further, the AAS may receive a multiple of AAS configuration information associated with a multiple of logic ports which ports can then be generated simultaneously based on their respective AAS configuration information. It will be readily obvious that different groups of Transceivers, RDN switches and antenna elements may be used simultaneously to generate different logical ports simultaneously based on the AAS configuration information for different signals applied to different inputs of the AAS. Even further, the AAS may generate different logical ports at different times as called for by the AAS configuration information for the different logical ports. The AAS configuration information may be based on protocols being performed by the communication network within which the AAS operates. These protocols may be performed by various equipment or nodes of the communication network.

While various aspects of the invention have been described above, it should be understood that they have been presented by way of example and not by limitation. It will be apparent to persons skilled in the relevant art (s) that various changes in form and detail can be made herein without departing from the spirit and scope of the present invention. Thus, the present invention should not be limited by any of the above-described exemplary aspects, but should be defined only in accordance with the following claims and their equivalents.

What is claimed is:

1. An AAS device comprising:
a Transceiver Bank;
a Radio Distribution Network (RDN) coupled to the Transceiver Bank; and
an Antenna Array coupled to the RDN where dynamic beam forming operations are performed by the Transceiver Bank, the RDN and the Antenna Array to process an input reference signal, said processed reference signal being a logical port of the Antenna Array and said beam forming operations are based on AAS configuration information received by the AAS.

2. The AAS device of claim 1 where the AAS configuration information is received by the AAS from one or more node elements of a communication network within which the AAS operates.

3. The AAS device of claim 1 where such device is integral with a base station of a cellular communication network within which the AAS operates.

4. The AAS device of claim 1 where the reference signal is defined by one or more specifications of a communication network within which the AAS operates.

5. The AAS device of claim 1 where the reference signal is defined by at least one communication standard being followed by a communication network within which the AAS operates.

6. The AAS device of claim 1 where the processed reference signal is a beam directed at a desired spatial location.

7. The AAS device of claim 1 where the processed reference signal is a beam directed at one or more mobile terminals.

8. The AAS device of claim 1 further comprising a processor coupled to the Transceiver Bank, the RDN and the Antenna Array, said processor being configured to receive the AAS configuration information and convert said information to control signals used by the Transceiver Bank, the RDN and Antenna Array to perform dynamic beam forming operations.

9. The AAS device of claim 8 where the processor is one of a microprocessor, a digital signal processor, a controller, a server and a computer system.

10. The AAS device of claim 1 where the AAS configuration information on which the dynamic beam forming operations are based define RF (Radio Frequency) characteristics of the Antenna Array.

11. The AAS device of claim 1 where the AAS configuration information is based on resource deployment tasks performed by a communication network in which the AAS operates.

12. A method for generating at least one logical port of an Active Antenna System (AAS), the method comprises:
performing, by the AAS, beam forming operations to process a reference signal applied to an input of the AAS where the beam forming operations are based on AAS configuration information received by the AAS.

13. The method of claim 12 where the beam forming operations are performed for a period of time having a length defined by the received AAS configuration information.

14. The method of claim 12 where the beam forming operations are performed for a period of time having a length based on a particular tasks being performed by a communication network within which the AAS operates.

15. The method of claim 12 where the step of performing beam forming operations to process the reference signal comprises determining whether there are sufficient resources to generate the at least one logical port.

16. The method of claim 15 where the AAS comprises a Transceiver Bank having a plurality of transceivers coupled to a Radio Distribution Network (RDN) having a plurality of controllable switches coupled to an Antenna Array having a plurality of antenna elements, where the resources comprise at least one of the Transceiver Bank, the RDN, the Antenna Array and an amount of power allocated to one or more of the plurality of transceivers used to perform the beam forming operations.

17. The method of claim 12 where a plurality of distinct logical ports are generated simultaneously.

18. The method of claim 12 where different groups of different logical ports are generated at different times for different periods of time in accordance with respective AAS configuration information.

19. The method of claim 18 where power is allocated across different groups of logical ports in accordance with respective AAS configuration information of the different groups.

20. The method of claim 12 where the AAS configuration information is based on protocols performed by equipment of a communication network in accordance with a communication standard being followed by the communication network within which the AAS operates.
